(19) United States
(12) Patent Application Publication
(10) Pub. No.: US 2023/0274083 A1
(43) Pub. Date: Aug. 31, 2023

(54) DIGITAL RATIONALIZATION OF CORRESPONDENCE

(71) Applicant: ACCENTURE GLOBAL SOLUTIONS LIMITED, Dublin 4 (IE)

(72) Inventors: Neeta Suresh PARVATIKAR, Bangalore (IN); Yathindra VENKATARAMANAPPA, Bangalore (IN); Wajid Mansur GAVANDI, Hyderabad (IN); Malvika SAXENA, Thane (IN); Ishmeet A. KAUR, Pitampura (IN); John W. RIZZETTO, Schaumburg, IL (US); Karen S. WEIDMAN, Ava, IL (US); Ashna Mausin KAZI, Mumbai (IN); Sanjeev CHATAKONDA, Kurnool (IN)

(73) Assignee: ACCENTURE GLOBAL SOLUTIONS LIMITED, Dublin 4 (IE)

(21) Appl. No.: 17/681,293

(22) Filed: Feb. 25, 2022

(51) Int. Cl. G06F 40/186; G06F 40/174; G06F 40/197; G06F 40/30; G06F 16/93

(52) U.S. Cl. CPC G06F 40/186; G06F 40/174; G06F 40/197; G06F 40/30; G06F 16/93

(57) ABSTRACT

A system and method for facilitating digital rationalization of a correspondence is disclosed. The system may include a processor including DTRE. The DTRE may receive a plurality of templates from at least one database coupled to the processor. The plurality of templates may pertain to a given correspondence. The DTRE may process the plurality of templates to identify static objects and dynamic objects. The static objects may be indicative of components that may be common across the plurality of templates. The dynamic objects may be indicative of components that may vary across the plurality of templates. The DTRE may generate, at least one rationalized template based on analysis of the identified static and dynamic objects. The at least one rationalized template may optimally represent the given correspondence, and may enable transmission of the given correspondence having content pertaining to any of the plurality of templates.

### BACKGROUND

Correspondence attributes to an important mode of communication in organizations. For example, the organizations associated with services such as, for example, banking, insurance, capital markets, travel, hospitality, health care, and other services may involve frequent customer interaction or communication. Each interaction or communication may be aided through a correspondence. However, with the trending rise in the practice of using the correspondence, there has also been an increasing amount in number of documents or templates pertaining to each correspondence that may be sent to the customer/client. If multiple instances of correspondence have occurred over several years, then there may be a high possibility of losing track of the past correspondence. This can also lead to duplication of correspondence and redundancy in data. Other associated concerns may include lack of consistency across documents, complexity in managing the correspondence and need for multiple communication systems for outbound correspondence. Further, there may be additional reasons for the rise in correspondence such as, for example, a need for updating particular information. For example, stages such as mergers and acquisitions in an organization may require update in the correspondence to include and/or update specific details. These details may include, for example, address, contact details, disclaimers, clauses and other information, which may need to be updated.

In order to effectively address these concerns, digital rationalization of correspondence can be a reliable solution to increase operational efficiency and facilitate higher customer satisfaction. In this regard, conventional solutions may still require high level of manual involvement for performing one or more steps during the digital rationalization. However, the manually supported solutions may be time-consuming and may lack operational efficiency, thus nullifying the merits of the digital rationalization.

### SUMMARY

An embodiment of present disclosure includes a system including a processor. The processor may include a document template rationalization engine (DTRE). The DIRE may receive a plurality of templates from at least one database coupled to the processor. The plurality of templates may pertain to a given correspondence. The DTRE may process the plurality of templates to identify static objects and dynamic objects. The static objects may be indicative of components that may be common across the plurality of templates. The dynamic objects may be indicative of components that may vary across the plurality of templates. The DTRE may generate at least one rationalized template based on analysis of the identified static and dynamic objects. The at least one rationalized template may optimally represent the given correspondence, and may enable transmission of the given correspondence having content pertaining to any of the plurality of templates.

Another embodiment of the present disclosure r ay include a method for facilitating digital rationalization of a correspondence. The method may include a step of receiving a plurality of templates for a given correspondence. The method may include a step of processing the plurality of templates to identify static objects and dynamic objects. The static objects may be indicative of components that are common across the plurality of templates. The dynamic objects may be indicative of components that vary across the plurality of templates. The method may include a step of generating, based on analysis of the identified static and dynamic objects, at least one rationalized template that optimally represents the given correspondence, and enables transmission of the given correspondence having content pertaining to any of the plurality of templates.

Yet another embodiment of the present disclosure may include a non-transitory computer readable medium comprising machine executable instructions that may be executable by a processor to receive a plurality of templates for a given correspondence. The processor may process the plurality of templates to identify static objects and dynamic objects. The static objects may be indicative of components that are common across the plurality of templates. The dynamic objects may be indicative of components that vary across the plurality of templates. Based on analysis of the identified static and dynamic objects, the processor may generate, at least one rationalized template that optimally represents the given correspondence, and enables transmission of the given correspondence having content pertaining to any of the plurality of templates.

### BRIEF DESCRIPTION OF DRAWINGS

FIG. 1 illustrates a system for facilitating digital rationalization of a given correspondence, according to an example embodiment of the present disclosure.

FIG. 2 illustrates an overall exemplary representation for digital rationalization of a given correspondence, according to an example embodiment of the present disclosure.

FIG. 3A illustrates an exemplary representation for generation of a rationalized template, according to an example embodiment of the present disclosure.

FIG. 3B illustrates an exemplary flow diagram representation depicting extraction of objects from templates having varying file types, according to an example embodiment of the present disclosure.

FIG. 4A illustrates an exemplary representation of a correspondence inventory, according to an example embodiment of the present disclosure.

FIG. 4B illustrates an exemplary representation that shows an example of trigger conditions or rules for extraction of the plurality of templates for a correspondence, according to an example embodiment of the present disclosure.

FIG. 4C illustrates an exemplary representation of the first stage of rationalization, according to an example embodiment of the present disclosure.

FIG. 4D illustrates an exemplary representation of results derived from three stage of rationalization, according to an example embodiment of the present disclosure.

FIG. 4E illustrates an exemplary representation of a rationalization eport, according to an example embodiment of the present disclosure.

FIG. 4F illustrates an exemplary representation of a summary of rationalization, according to an example embodiment of the present disclosure.

FIGS. 4G-4I illustrate exemplary representations of excel file, front page word file, and letter body word file, respectively pertaining to a rationalized template, according to example embodiments of the present disclosure.

FIGS. 5A-5B illustrate exemplary representations for generation of the rationalized template through ACRE 108, according to an example embodiment of the present disclosure.

FIG. 6 illustrates an exemplary representation for showing recommendation of grouping of new correspondence by a learning engine, according to an example embodiment of the present disclosure.

FIG. 7 illustrates an exemplary representation of a test automation framework, according to an example embodiment of the present disclosure.

FIG. 8A illustrates an exemplary representation of a template level verification, according to an example embodiment of the present disclosure.

FIGS. 8B-8B illustrate exemplary representations of various verification levels in a testing framework, according to an example embodiment of the present disclosure.

FIG. 9 illustrates a hardware platform for implementation of the disclosed system, according to an example embodiment of the present disclosure.

FIG. 10 illustrates a flow diagram for facilitating digital rationalization of a correspondence, according to an example embodiment of the present disclosure

### DETAILED DESCRIPTION

For simplicity and illustrative purposes, the present disclosure is described by referring mainly to examples thereof. The examples of the present disclosure described herein may be used together in different combinations. In the following description, details are set forth in order to provide an understanding of the present disclosure. It will be readily apparent, however, that the present disclosure may be practiced without limitation to all these details. Also, throughout the present disclosure, the terms “a” and “an” are intended to denote at least one of a particular element. The terms “a” and “a” may also denote more than one of a particular element. As used herein, the term “includes” means includes but not limited to, the term “including” means including but not limited to. The term “based on” means based at least in part on, the term “based upon” means based at least in part upon, and the term “such as” means such as but not limited to. The term “relevant” means closely connected or appropriate to what is being performed or considered.

### Overview

Various embodiments describe providing a solution in the form of a system and a method for digital rationalization of a correspondence. The system may include a processor. The processor may include a document template rationalization engine (hereinafter also referred to as DTRE). The DTRE may receive a plurality of templates from at least one database coupled to the processor. The plurality of templates may pertain to a given correspondence. The DTRE may process the plurality of templates to identify static objects and dynamic objects. The static objects may be indicative of components that may be common across the plurality of templates. The dynamic objects may be indicative of components that may vary across the plurality of templates. The DTRE may generate, at least one rationalized template based on analysis of the identified static and dynamic objects. The at least one rationalized template may optimally represent the given correspondence, and may enable transmission of the given correspondence having content pertaining to any of the plurality of templates. In an example embodiment, the at least one rationalized template may be generated in a series of steps. The series of step may include determining variances between the dynamic objects, rationalizing the determined variances and merging the rationalized variances with the static objects. In another example embodiment, the document template rationalization engine may be operatively coupled with an artificial intelligence (AI) based correspondence rationalization engine (hereinafter, referred to as AICRE). The AICRE may facilitate generation of the at least one rationalized template based on AI based paraphrasing and semantic analysis.

Exemplary embodiments of the present disclosure have been described in the framework for facilitating digital rationalization of a correspondence. The embodiments may describe a system and a method to perform digital rationalization of plurality of templates to generate a rationalized template. The digital rationalization may enable to reduce hundreds or thousands of templates to a relatively fewer number of the templates (such as, for example, less than 100 templates). The digital rationalization may facilitate to identify static and dynamic objects within each template of the plurality of templates. The system/method may assess occurrence of each identified object across each of the plurality of templates to determine if the objects are unique, common, or re-occurring. Thus, the solution provides simultaneous comparison of a single template with multiple templates, thereby making the process faster and more efficient. Based on the assessment and processing, the digital rationalization may facilitate to significantly decrease the number of templates by eliminating/reducing duplicate documents and redundancy across multiple legacy systems. The system and method may thus enhance consistency across documents, thus reducing complexity in managing multiple correspondences. In an example embodiment, the DTRE may be operatively coupled with the AICRE that reduce the manual efforts and enhance automation with respect to the digital rationalization. The system and method may also facilitate to utilize the output i.e. the rationalized template to generate multiple forms of the given correspondence based on a set of rules. In general, the system and method may manage a huge number of correspondence templates to be rationalized to a smaller number, thus resulting in easy maintenance, cost-savings and reduced time to generate and/or maintain the correspondence. The system and method of the present disclosure may be applied to several applications that involve heavy customer interaction in fields, such as, for example, banking, insurance, capital markets, travel, hospitality, health care, and other such fields. For example, processes such as insurance processing, loan processing and other such applications may be required to manage a large amount of documents/customer correspondence. However, one of ordinary skill in the art will appreciate that the present disclosure may not be limited to such applications. The system may also be integrated with other tools such as Customer Communications Management (CCM) tool to improves creation, delivery, storage and retrieval of outbound and interactive communication. Several other advantages may be realized.

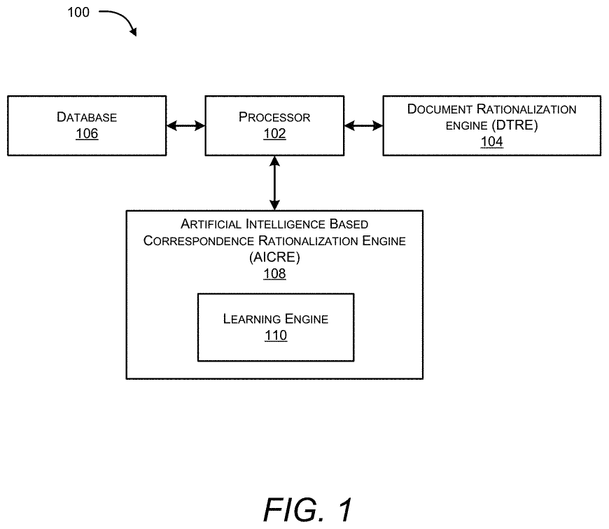

FIG. 1 illustrates a system 100 for facilitating digital rationalization of a given correspondence, according to an example embodiment of the present disclosure. The system 100 may be implemented by way of a single device or a combination of multiple devices that are operatively connected or networked together. The system 100 may be implemented in hardware or a suitable combination of hardware and software. The system 100 includes a processor 102. The processor may be coupled to at least one database 106 that may store a plurality of templates. The processor 102 may include DTRE 104. The DTRE 104 may receive the plurality of templates from the at least one database 106. The plurality of templates may pertain to the given correspondence. The DTRE 104 may process the plurality of templates to identify static objects and dynamic objects. The static objects may be indicative of components that may be common across the plurality of templates. The dynamic objects may be indicative of components that may vary across the plurality of templates. The DTRE 104 may generate, at least one rationalized template based on analysis of the identified static and dynamic objects. The at least one rationalized template may optimally represent the given correspondence, and may enable transmission of the given correspondence having content pertaining to any of the plurality of templates.

In an example embodiment, the document template rationalization engine may be operatively coupled with AICRE 108. Based on the analysis of the identified static and dynamic objects, the AICRE 108 may enable generation of the at least one rationalized template based on AI based paraphrasing and semantic analysis. The AICRE 108 may include a learning engine 110 that may receive the plurality of templates for the given correspondence. In an embodiment, the learning engine 110 may learn from the generated at least one rationalized template for the given correspondence. This may facilitate the learning engine 110 to revise the at least one rationalized template upon receipt of another template for the given correspondence based on a AI document classification unit. In an alternate example embodiment, the AICRE 108 may analyze a second correspondence requiring rationalization and may provide recommended groupings of similar correspondences.

The system 100 may be a hardware device including the processor 102 executing machine readable program instructions to facilitate digital rationalization of a correspondence. Execution of the machine readable program instructions by the processor 102 may enable the proposed system to facilitate the digital rationalization of the correspondence. The “hardware” may comprise a combination of discrete components, an integrated circuit, an application-specific integrated circuit, a field programmable gate array, a digital signal processor, or other suitable hardware. The “software” may comprise one or more objects, agents, threads, lines of code, subroutines, separate software applications, two or more lines of code or other suitable software structures operating in one or more software applications or on one or more processors. The processor 102 may include, for example, microprocessors, microcomputers, microcontrollers, digital signal processors, central processing units, state machines, logic circuits, and/or any devices that manipulate data or signals based on operational instructions. Among other capabilities, processor 102 may fetch and execute computer-readable instructions in a memory operationally coupled with system 100 for performing tasks such as data processing, input/output processing, data/object extraction, object identification and/or any other functions. Any reference to a task in the present disclosure may refer to an operation being or that may be performed on data.

The given correspondence may pertain to a communication received and/or sent to a client/user/customer in the form of a document/letter. Several such documents may be stored in the database 106, wherein each document may pertain to a correspondence. Each document may include a template (of the plurality of templates). In an example, the correspondence may be associated with an event or a stage such as, for example, divorce, retirement, death and other such events/stages. In another example, the correspondence may pertain communication of financial events such as maturing of funds, communication related to retirement fund, life insurance related correspondence to a dependent, reminder for payment of loan installment, completion of loan period and other such communication. In another example, the correspondence may also pertain to communication of legal events such as, for example, divorce related correspondence, legal notices related correspondence and other such events. In another example, the correspondence may also pertain to communication of work engagement related events such as, for example, welcoming/onboarding letter, engagement correspondence, work experience related correspondence and other similar communications. It may be appreciated that mentioned correspondence examples are only provided for clarity and better understanding but the correspondence may not be limited to the mentioned examples. The plurality of templates pertaining to documents associated with each correspondence may thus include diversity or variation in content and/or variation in representation of data. However, accumulation of thousands of different templates for each correspondence may lead to duplication and redundancy, which may make the data management complex in nature. The DRTE 104 performs the digital rationalization to reduce the complexity and enhance the data management.

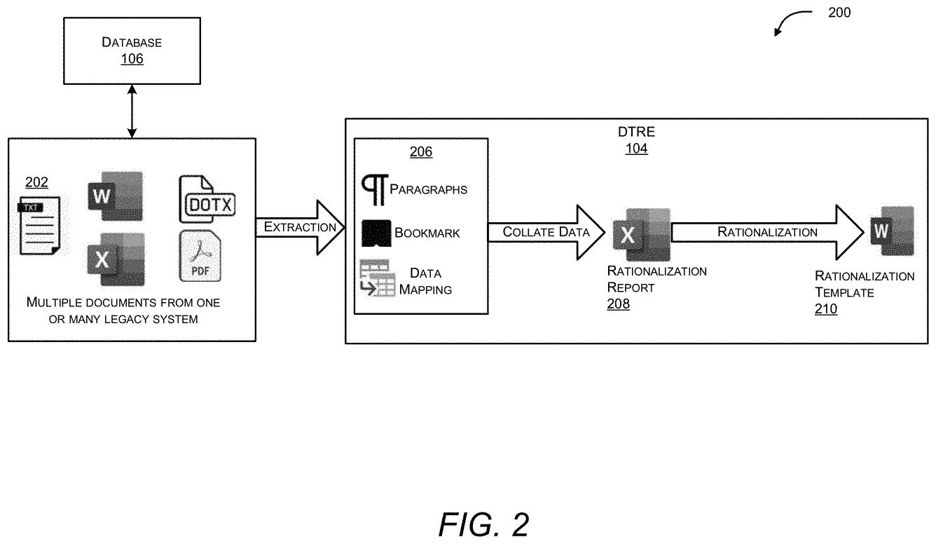

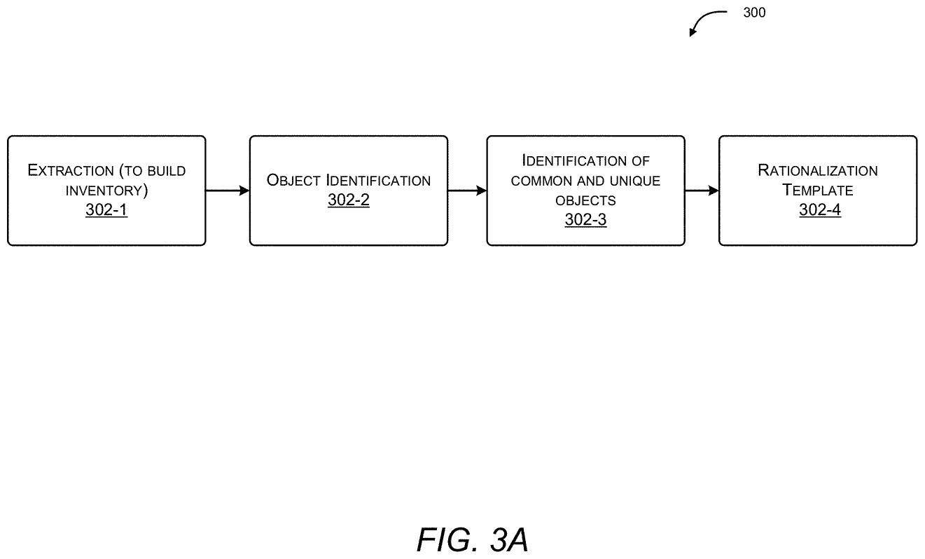

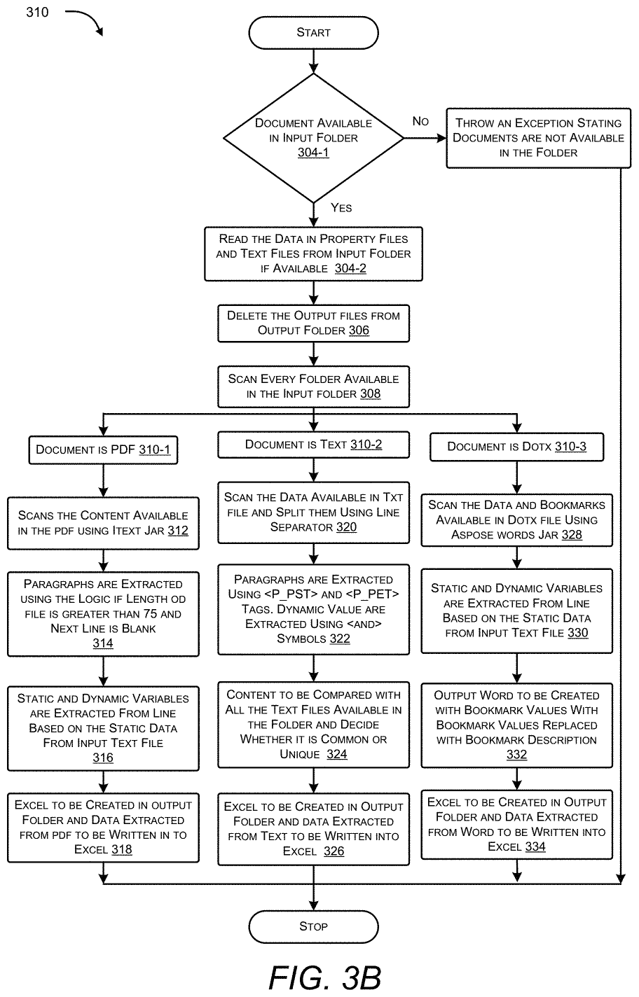

FIG. 2 illustrates an exemplary representation 200 for digital rationalization of a given correspondence, according to an example embodiment of the present disclosure. As illustrated in FIG. 2, the DTRE 104 may receive a plurality of templates 202 for a given correspondence from the database 106. The plurality of templates 202 may be stored in the database 106 in the form of multiple documents in one or more file formats. The file formats may include for example, text file, pdf file, word file, dotx file, excel sheet and other such formats. In an example embodiment, the DTRE 104 may include a rationalization automation tool for performing tasks such as, for example, object identification, object marking, object characteristic identification and object analysis within various Correspondence. In an example embodiment, the DTRE 104 may utilize a Extract-Transform-Load (ETL) based technique to extract objects from each template so as to identify static objects and dynamic objects across the plurality of templates 202. In an example embodiment, the static objects and the dynamic objects may be portions of text that form part of the plurality of templates. For example, the DTRE 104 may extract objects 206 such as, for example, paragraphs, contents, bookmarks based on data mapping across multiple document types/plurality of templates 202. The extracted objects 206 may be collated to generate a rationalization report 208. In an example embodiment, the rationalization report 208 may be an excel sheet including details of the extracted objects i.e. extracted paragraphs, contents, bookmarks, the data mapping, along with indication of static and dynamic nature of the extracted objects. Based on the rationalization report 208, the DTRE 104 may perform the digital rationalization to generate the at least one rationalized template 210. Further details pertaining to the generation of the rationalization report is provided in FIG. 3A.

FIG. 3A illustrates an exemplary representation 300 for generation of a rationalized template 302-4, according to an example embodiment of the present disclosure. As illustrated in FIG. 3A, the generation of the rationalization template 308 may occur in a series of steps. At 302-1, the DTRE 104 may perform extraction of files/letters or templates across multiple legacy systems. At 302-2, the DIRE 104 may analyze extracted objects in each template to identify object characteristics with respect to the extracted objects. For example, object characteristics may indicate if the extracted object are static or dynamic, re-occurring common or unique and other such characteristics within each template. The “static” objects may include, for example, text portions and/or paragraphs that have a minimum tendency for change. One example of “static” objects within a template/letter may include greetings or salutation portion or text such as “Dear.”, “Hope you are doing well” and other such objects. The dynamic objects may include text portions and/or paragraphs that may pertain to details that may have a higher tendency to change. For example, the “dynamic” objects may include customer/entity address, customer/entity name, contact details, clauses pertaining to a specific customer or entity, and other such information. The “common” objects may pertain to commonly occurring phrases/text such as, for example, formal concluding text such as “Yours sincerely”, an acknowledgement statement, a statement for expressing gratitude and other such verses or text commonly used in templates. The “unique” objects may include text, paragraphs, or verses that do not commonly occur that may be specific to a customer/entity. Further, referring to FIG. 3A, at 302-3, the DTRE 104 may assess occurrence of each identified object across each template of the plurality of templates, based on which the identified object is determined to be unique, common, or re-occurring. This means that objects in a single template are compared across all the plurality of templates to identify unique, common, and/or re-occurring objects. In one embodiment, the comparison is performed simultaneously. Based on this analysis, the DTRE 104 may identify an estimate or number of the rationalized templates that can be derived for the correspondence. In an example embodiment, the DTRE 104 may also generate a summary of rationalization that may indicate the extent to which reduction in the number of templates may occur after the execution of the digital rationalization with respect to an initial number of templates. At 302-3, the DTRE 104 may also generate a rationalization report including details of the extracted objects, such as, for example, object name, object marking, object characteristics and other details for each individual template. At 302-4, based on the output of the earlier steps, the identified objects across the plurality of templates may be evaluated to finalize the objects that may be included in the rationalized template (hereinafter interchangeably referred to as “proposed template”). In an example embodiment, the finalization or generation of the rationalized template may be partially supported based on manual assessment and/or feedback. In another example embodiment, the generation of the rationalized template may be completely automated.

In reference to 302-1 in FIG. 3A, the processor/DTRE 104 may include a file extraction tool for extracting existing letters/templates and/or pre-defined rules/trigger conditions. The DTRE 104 may first determine a scope for rationalization based on at least one of a number of types of letters/templates or number of files under each letter type/template type in inventory and legacy applications from which these templates are generated. The DTRE 104 may then map the file names of each template in the inventory type with the extracted templates so as to obtain a correspondence inventory. In reference to 302-2 in FIG. 3A, the DTRE may include the rationalization automation tool to perform extraction of objects from each template based on file type of the document pertaining to the template. For example, the rationalization automation tool may identify the difference in file type such as, for example, a word file or a pdf file, based on which the extraction of the objects may be performed. In an embodiment, the rationalization automation tool may receive plurality of templates as input (templates with a specific file type such as, for example, word file, pdf file, excel file, dotx file, text file and other file types) such that after extraction of objects (and other details) from the input, the rationalization report may be generated at the end of the step 302-2. The rationalization report may include summarized details such as, for example, static objects, dynamic objects, bookmark information, paragraphs and other details. In an example, the rationalization report may be generated in excel format. FIG. 3B illustrates an exemplary flow diagram representation 310 depicting extraction of objects from templates having varying file types, according to an example embodiment of the present disclosure. As illustrated in FIG. 3B, at 304-1, the template (of the plurality of templates) may be received from the database in an input folder of the system. Each template may be in the form of a document having a particular file type. At 304-2, the extraction tool may read data in property files and text files pertaining to the plurality of templates, and may delete output files from output folder. At 308, the rationalization automation tool may scan each folder available in the input folder and evaluate the file type, such as, for example, pdf file (310-1), text file (310-2) and/or DOTX file (310-3). In an example embodiment, if the template has text file type, the rationalization automation tool may use technology stack such as, for example, JAVA, Apache POI, and Log4j2. In an alternate example embodiment, if the template has pdf file type, the rationalization automation tool may use technology stack such as, for example, JAVA, iText jar, Apache POI, and Log4j2. In an alternate example embodiment, if the template has DOTX file type, the extraction tool may use technology stack such as, for example, Java, Aspose words, Sprie, Apache POI, and Log4j2.

In an example embodiment, if the template or document may be a pdf file (310-1), at 312, the rationalization automation tool scans the content available in the pdf by using tools such as, for example, iTEXT Jar. This may be followed by extraction of paragraphs (at 314) using a pre-defined logic, such as, for example, extraction may be done “if length of file is greater than 75 and next line is blank”. At 316, static objects and dynamic objects may be extracted based on the pre-defined static data from input text file. At 318, an excel file may be created in output folder and data extracted from pdf may be written into the excel file. In an example embodiment, prior to the extraction, the rationalization automation tool may read the files which contain static object and/or regular expression (regex) details for identification of dynamic objects. In an alternate example embodiment, the rationalization automation tool may scan all templates in the input folder having pdf file type available, extract the data from the pdf files and split them based on the regex details. In an example embodiment, if the template or document may be a text file (310-2), at 320, the rationalization automation tool scans the content available in the text file and further split the content using line separator tools. This may be followed by extraction of paragraphs (at 322) using <P_PST> and <P_PET> tags. The extraction tool may then extract dynamic objects using < and > symbols. At 324, the content may be compared with all the text files available in the folder and the rationalization automation tool may decide whether it is common or unique static objects. The dynamic objects may be extracted based on the pre-defined static data from input text file. In an example embodiment, the rationalization automation tool may decide that an object is common if the object may be available in all the files in folder. In an alternate example embodiment, the rationalization automation tool may decide that an object is unique and recurring if the object may be available in more than one folder/template but not in all folder/templates. In an example embodiment, the extraction tool may decide that an object is unique if the object may be available in only one template/folder. At 326, an excel file may be created in the output folder of the system and the data that extracted from the text file may be written into the excel file. In an example embodiment, if the template or document may be a DOTX file (310-3), at 328, the rationalization automation tool scans data and bookmarks available in DOTX file using techniques such as, for example, Aspose words jar. At 330, the rationalization automation tool may extract static objects and dynamic objects based on the pre-defined static data from input text file. In an example embodiment, templates/files having bookmark details and static field details may also be placed in the input folder so that the extraction tool may get all the information pertaining to the bookmark details and the static field details, prior to actual reading of documents. In an example embodiment, the static and dynamic objects may be assigned a unique identifier such as, for example, an individual object number may be assigned. At 332, an output word document may be created with bookmark values and the bookmark values are replaced with bookmark description. At 334 and in an example embodiment, an excel file may be created in output folder and data extracted from DOTX may be written into the excel file. In an alternate embodiment, when the template is DOTX file, then in addition to the excel file, the extraction tool may also generate a word file with bookmarks replaced by bookmark description.

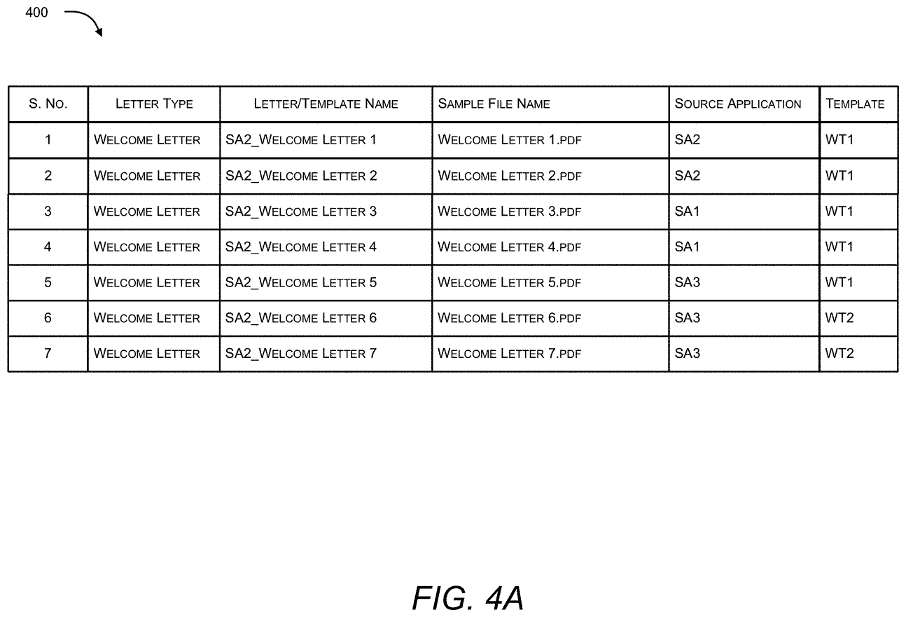

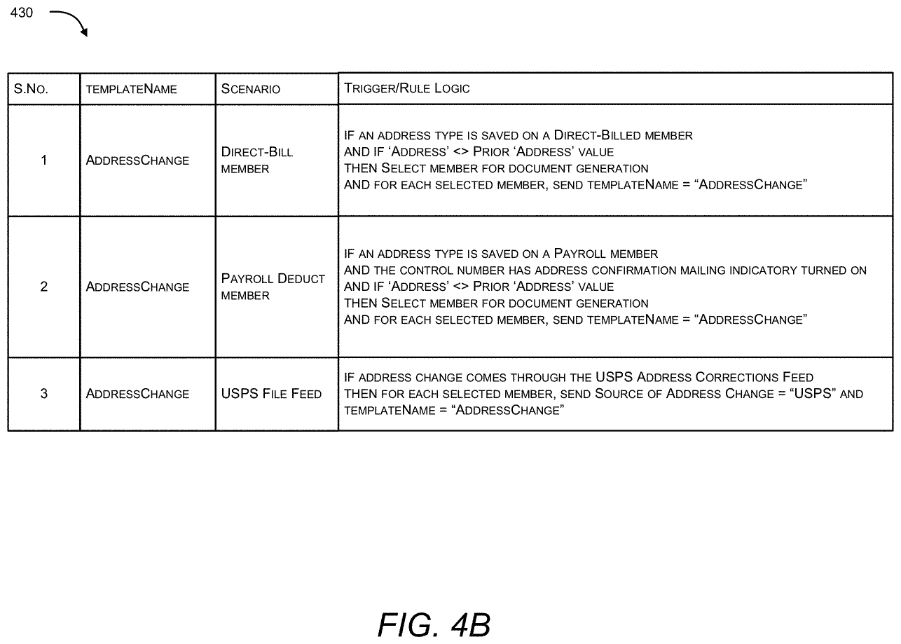

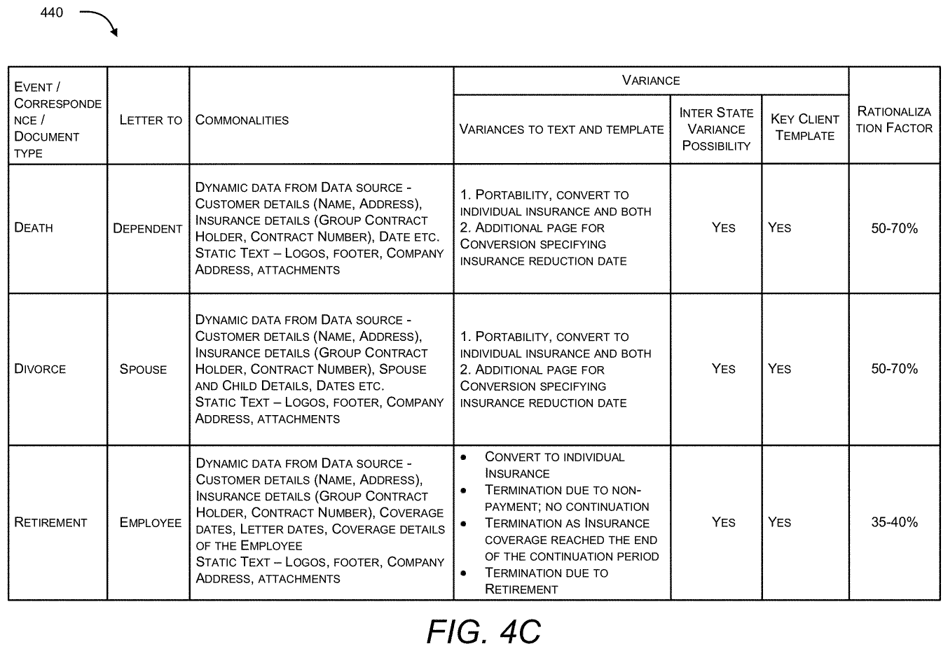

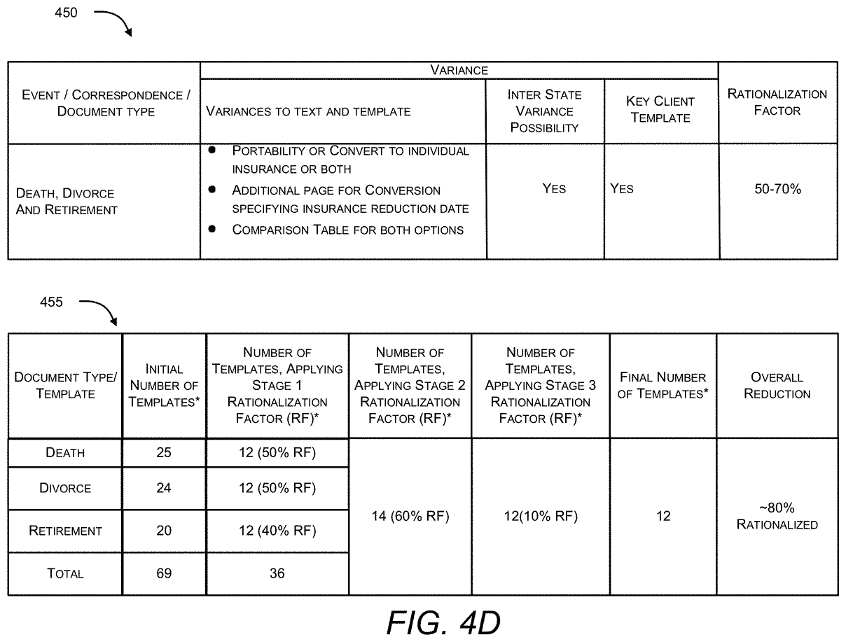

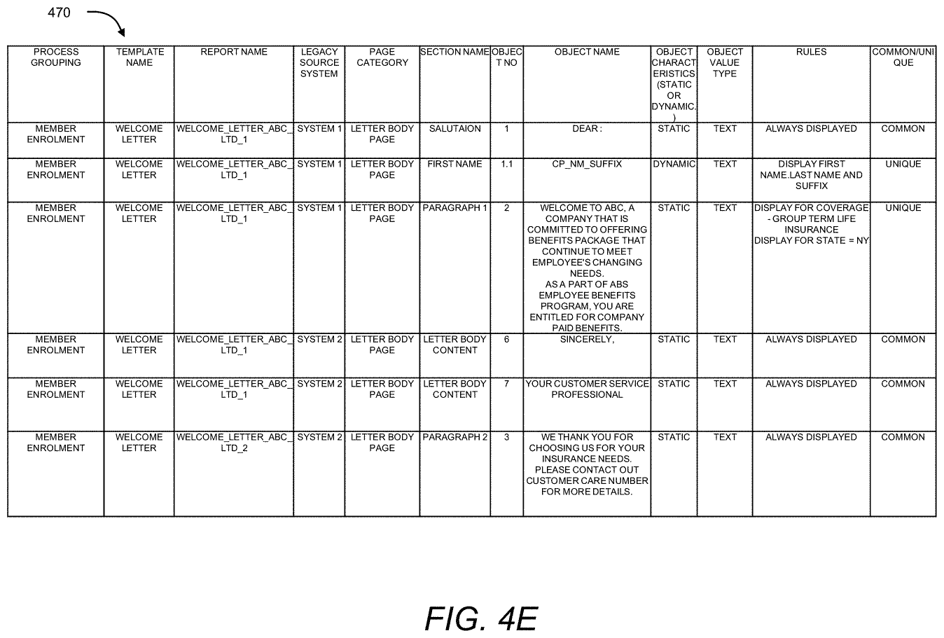

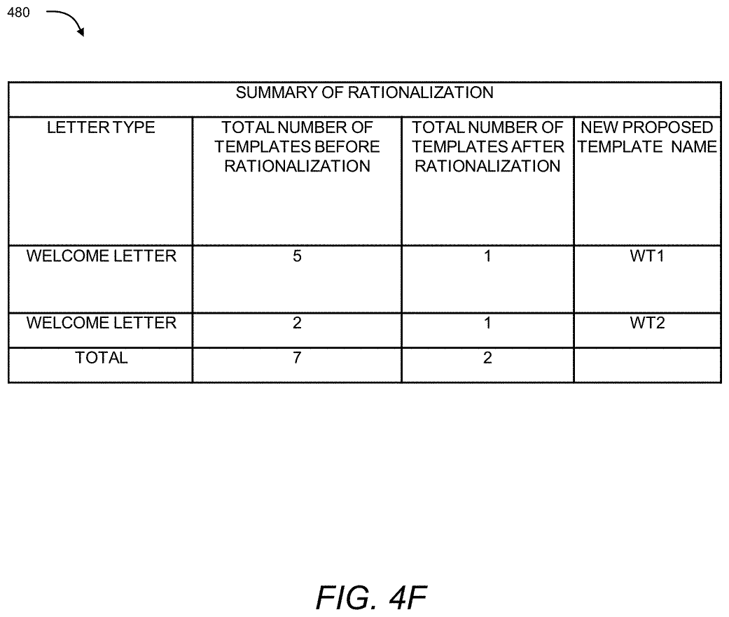

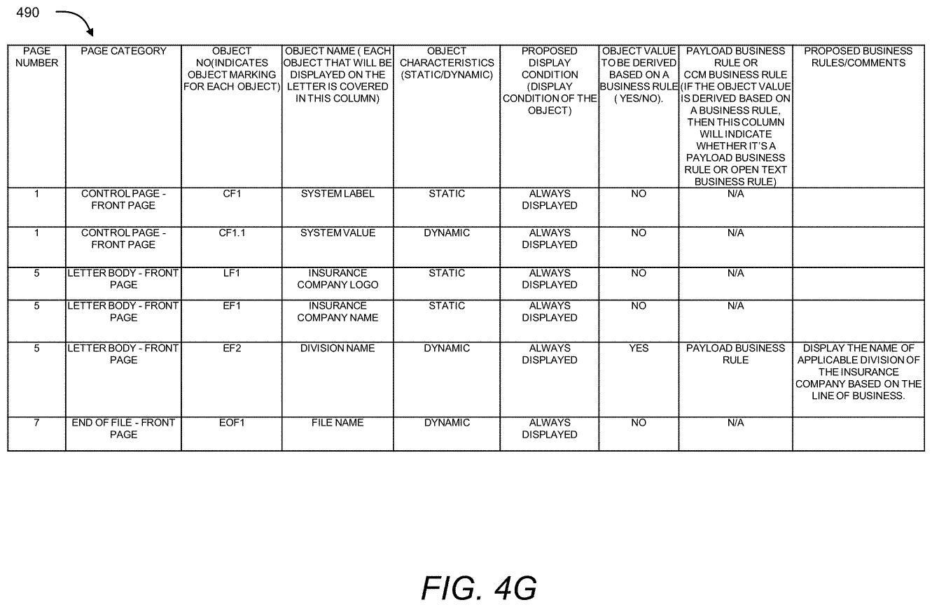

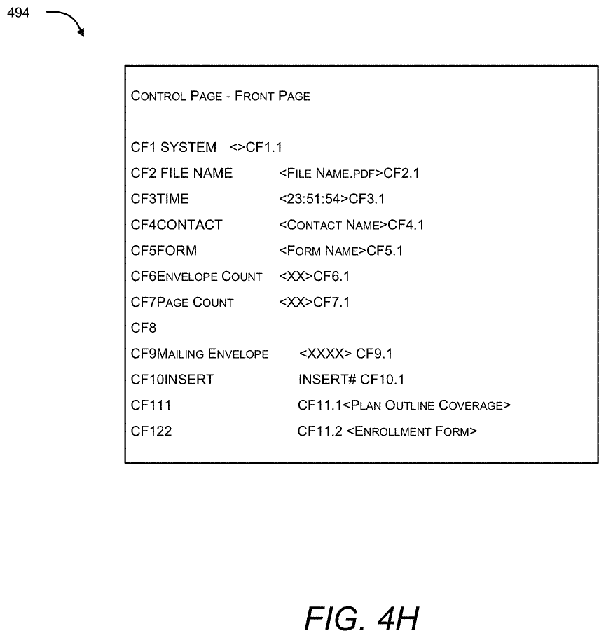

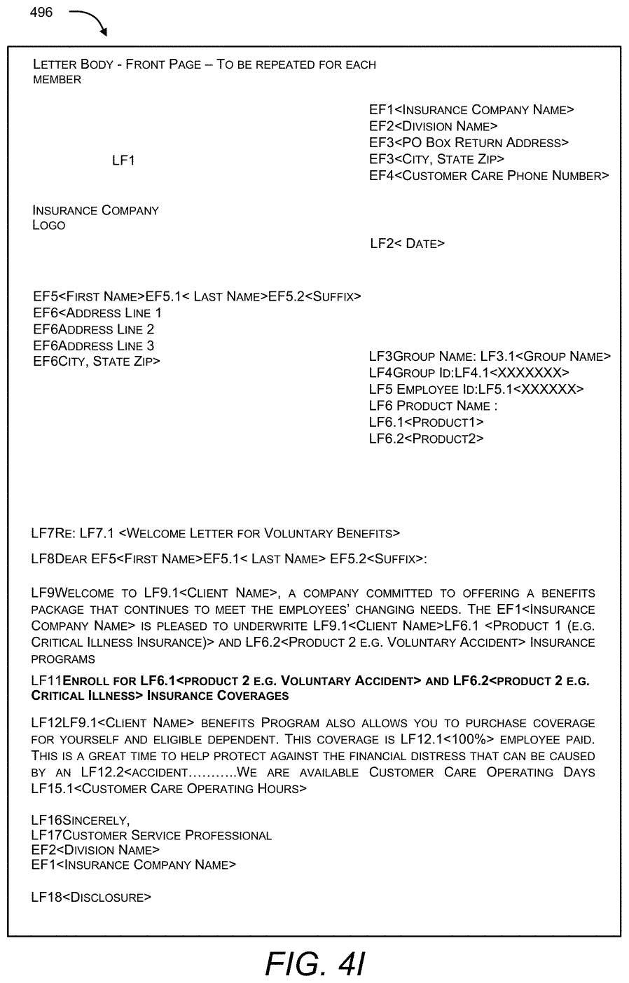

Referring back to FIG. 3A, in step 302-1, FIG. 4A illustrates an exemplary representation 400 of the correspondence inventory, according to an example embodiment of the present disclosure. As shown in FIG. 4A and in accordance with an example embodiment, the correspondence inventory 400 may be shown in a tabular format. It may be appreciated that the correspondence inventory shown in FIG. 4A is in a tabular format but the inventory may be represented in several other formats. The correspondence inventory 400 mainly pertains to a correspondence related to “Welcome letter” and hence the inventory shows the corresponding plurality of templates listed in the “template name” as “SA2_Welcome Letter 1, SA2_Welcome Letter 2. SA2_Welcome Letter 3” The inventory also mentions the names of the files corresponding to the template, which indicates the type of files as “pdf” as well as information pertaining to legacy application/source application and template grouping. In an alternate example embodiment and as depicted in Table 1 below, the correspondence inventory may also include an inventory based summary that may provide a brief overview the available templates for various correspondence. As depicted in Table 1, the inventory based summary may indicate plurality of templates for various correspondence such as, for example, “Address change letter”, “Benefit change letter” and other templates as shown the “Type of letter or template” column. The inventory based summary may indicate the number of templates available for each type of correspondence, both as total number and based on the source application.

TABLE 1
Inventory based summary

| Type of letter | Source | Source | Source | |
|---|---|---|---|---|
| or template (for | Application | Application | Application | Grand |
| correspondence) | 1 | 2 | 3 | Total |
| Address Change | 1 | 1 | 3 | 5 |
| Letter | | | | |
| Benefit Change | | 2 | 1 | 3 |
| Letter | | | | |
| Direct Bill | 1 | 1 | | 2 |
| Self Bill | 1 | | 2 | 3 |
| Welcome Letter | 2 | 2 | 3 | 7 |
| Grand Total | 5 | 6 | 9 | 20 |

In an example embodiment, in the same step of deriving the correspondence inventory (step 302-1 of FIG. 3A), the system may also extract trigger conditions and/or business rules that generate the templates by using, for example, an extraction utility. In reference to the trigger conditions mentioned above, FIG. 4B illustrates an exemplary representation 430 that shows an example of trigger conditions or rules for extraction of the plurality of templates for a correspondence, according to an example embodiment of the present disclosure. As shown in FIG. 4B, the trigger conditions or rules may be in tabulated form and may indicate a template name and scenario (indicating type of correspondence). The tabulated form may also indicate the trigger condition or rule to be followed in case any of the mentioned scenario occurs. For example, for a scenario related to direct bill member, a trigger/rule may be pre-stored stating that “If an address type is saved on a direct-billed member and if ‘address’< > prior ‘address’ value then select member for document generation and for each selected member, send templatename=“addresschange”.” Similarly other trigger conditions/rules may be used as mentioned in the table provided in FIG. 4B. In an example embodiment, the trigger condition/rule may be defined by a user. In an alternate example embodiment, the trigger condition/rule may be automatically defined by the system 100.

Referring back to FIG. 2, and as per an alternate example embodiment, the DIRE 104 may be executed across a plurality of stages to attain the digital rationalization. Each stage of the plurality of stages may be based on how the plurality of templates are stored within and/or across one or more legacy systems. The term “legacy system” refers to an old or outdated system, technology or software application that continues to be used by an organization because it still performs the functions it may be initially intended to do. The term legacy system may also generally refer to systems that no longer have support and maintenance, and are limited in terms of growth, but which cannot easily be replaced. In an example embodiment, plurality of stages may include a first stage that may occur within each legacy system such that:
For each legacy system, the DTRE may identify the types of templates required (based on the correspondence)
For each type of template, the system may identify the commonalties and variances
The system may identify templates that are duplicate and can be rationalized, along with the rules that can be configured to render the documents
   In an example embodiment, the first stage may lead to reduction in the number of templates by at least 40% to 50%. The plurality of stages may include a second stage that may occur across different legacy systems, wherein:
After arriving at the document templates within the legacy systems (from the first stage), the system may compare commonalities across the legacy systems
In the second stage, the system may also identify unique templates across document types and the rules required to cater to variances
   In an example embodiment, the second stage may lead to further reduction in the number of templates (derived from first stage) by at least 30%.
   The plurality of stages may include a third stage that may occur across different legacy systems such that in the third stage:
The system may identify areas for further optimization,
The system may identify areas for more rules-oriented optimization
   In an example embodiment, the third stage may lead to further reduction in the number of templates (derived from first stage) by at least 10%. In an example embodiment, the first stage, second stage and the third stage may be executed based on manual feedback. In an alternate example embodiment, the first stage, second stage and the third stage may be executed completely by the system in an automated manner. In an example embodiment, the execution of the DIRE 104 across a plurality of stages may facilitate to considerably filter the number of templates, for example, from a starting number of around 1000 templates to a target of around 100 templates (after implementation of all the 3 stages). It may be appreciated that the number of stages and the examples may not be limited to mentioned embodiments and may be customizable based on the requirement of the application.

In reference to the plurality of stages mentioned hereinabove, FIG. 40 illustrates an exemplary representation 440 of the first stage of rationalization, according to an example embodiment of the present disclosure. As shown in FIG. 40, the first stage of rationalization may include identifying types of templates required (based on the correspondence) such that for each type of template, the system may identify the commonalties and variances, as shown in the table of FIG. 40. The commonalties may correspond to common objects/data that may be present in different types of template, while the variances may pertain to variation in text/objects across the multiple templates. In an example embodiment, the commonalties may pertain to static objects/data and the variances may pertain to dynamic objects/data. The system may also evaluate inter-state variance possibility that may facilitate to determine variances between the dynamic objects. The inter-state variance possibility may pertain to difference in regulations or laws based on difference in location/country/state/regions. For example, two different states or countries may have varying insurance laws that may lead to the inter-state variance for correspondence being issued for different locations. In this example, it may be possible that the number of days before which the employee needs to enroll for a benefit may be 60 days for one state/location and 90 days for the other state/location. These interstate variances are determined by a rationalization automation tool such that the common and unique objects are identified by the tool. Based on above information, the system may thus identify templates that are duplicate and can be rationalized. In reference to the plurality of stages mentioned hereinabove, FIG. 4D illustrates an exemplary representation 450 of outcome from three stage of rationalization, according to an example embodiment of the present disclosure. As shown herein, the number of templates are analyzed across the legacy systems (for example, correspondence related to death, divorce and retirement). In this stage, the system may identify unique templates across legacy systems to further reduce the number of templates, for example, by a margin of 50% to 70%. In an example embodiment, the rationalized template (obtained at the end of rationalization) may be generated in a series of steps. In the first step, the system may determine variances between the dynamic objects. In the second step, the system may rationalize the determined variances. In the third step, the system may merge the rationalized variances with the static objects to generated the at least one rationalized template. As given in FIG. 4D, the system dearly reduces the number of templates from 69 to a final number of 12 templates, thereby giving approximately an overall 80% of rationalization. Looking at individual stages, out of 69 templates (25, 24 and 20 for correspondence corresponding to death, divorce and retirement respectively), the execution of the first stage resulted in 12 templates for each event (total of 36 templates). After the execution of stage 2, only 14 templates remained, which further reduced to 12 templates, thereby giving approximately 80% rationalization.

As earlier mentioned in 302-2 of FIG. 3A, a rationalization report may be generated, which includes details of the extracted objects, such as, for example, object name, object marking, object characteristics and other details for each individual template. FIG. 4E illustrates an exemplary representation 470 of a rationalization report, according to an example embodiment of the present disclosure. The rationalization report 470 may include information such as, for example, “Process grouping” that describes grouping based on policy life cycle (in an example of new policy registration as an event or correspondence). The rationalization report 470 includes template name, source or legacy system, page category of extracted object, section name indication the type of object (such as paragraph, letter body content) and object name. The rationalization report 470 may also include the details pertaining to object identity or unique identifier (object number) object characteristics (static or dynamic) and if the objects are common or unique. For example, the object pertaining to salutation “Dear” (as shown in 470) may be a static object as it remains constant, whereas the “First name” is dynamic as it may change with the names of the customer/client. Further, each object may be associated with rules (or a set of rules) regarding the manner in which the object needs to be represented. For example, the object pertaining to salutation “Dear” (as shown in 470) is associated with rule “Always displayed” that also indicates that the object is “common”. In another example, the object pertaining to first name is identified as unique and may be associated with rule “Display First Name. Last Name And Suffix” that may indicate the specific pattern in which the name may be displayed.

Referring back to 302-3 of FIG. 3A, detailed analysis of common and unique objects may be performed based on the rationalization report (302-2). Based on the number of unique objects found, the system may assess whether the unique objects found across the plurality of templates can be combined in one template or if the unique objects may need to be captured in different templates. In an example embodiment, this assessment may be performed based on manual feedback. In an alternate example embodiment, this assessment may be performed completely in an automated manner. This step may also lead to generation of summary of rationalization that indicates the number of proposed templates that may be obtained after the digital rationalization. FIG. 4F illustrates an exemplary representation 480 of the summary of rationalization, according to an example embodiment of the present disclosure. As shown in FIG. 4F and in an example embodiment, the summary of rationalization may be a tabulated information indicating number of templates before rationalization and after rationalization (rationalized template) along with other details such as name of the proposed template or the rationalized template. Referring back to FIG. 3A, rationalized template may be generated at 302-4 based on the output from the previous steps. In an example embodiment, based on the number of proposed template or the rationalized template as provided in the summary of rationalization (FIG. 4F), the system may generate the rationalized template. The rationalized template may be a illustrative representation of rationalized content. In an example embodiment, the rationalized template is created in word document format, from which an excel file is generated. FIGS. 4G-4I illustrate exemplary representations 490, 494, and 496 of excel file, front page word file, and letter body word file, respectively pertaining to rationalized template, according to example embodiments of the present disclosure. As illustrated in FIGS. 4H and 4I, the front page word file (494) and the letter body word file (496) of the rationalized template are examples of the rationalized template created in word document format. These files include object numbers such as CF1, CF2, . . . CF122 (in case of 494) and LF1, EF5, EF6, . . . LF17, LF18 (in case of 496). Each object number may be considered as a unique identifier for the identified objects during rationalization. The excel file 490 may include all the details of each object derived from the word files (494, 496) of the rationalized template. In an example embodiment, the details may include object name, object number or the unique identifier, object characteristics, display condition object that may be derived based on business rule or not, text to be printed, object that may be derived from the payload and other such details. In an example embodiment, a payload spreadsheet may be created from the excel file 490 of the rationalized template. The term “payload” may refer to dynamic data sent by a source to the CCM tool in formats, such as, for example, JSON, XML, and other formats. The CCM tool i.e. Customer Communication Management tool may be considered as a system/product used for document generation based on the proposed product templates. The payload spreadsheet may give details of all the dynamic objects that may come from the policy administration and passed on to the CCM tool. In an example embodiment, the CCM tool may utilize this information and may facilitate generating a final practical template, either based on manual feedback or in an automated way. In an alternate embodiment, prior to generating at the final practical template, core correspondence guidelines (COG) document may be finalized. The COG document may be a standard guidelines document that may indicate rules or strategies on common objects to be displayed on the final practical template.

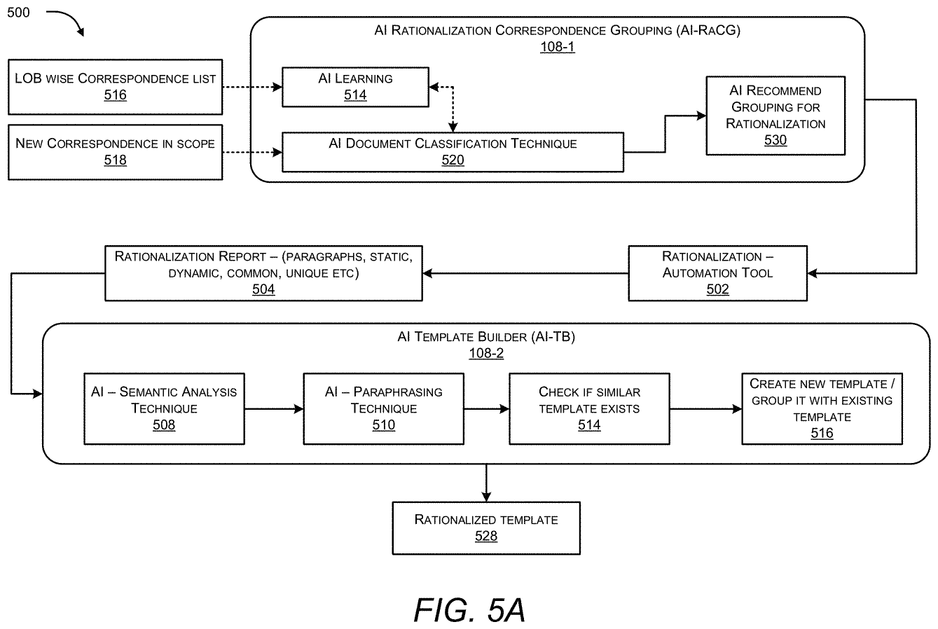

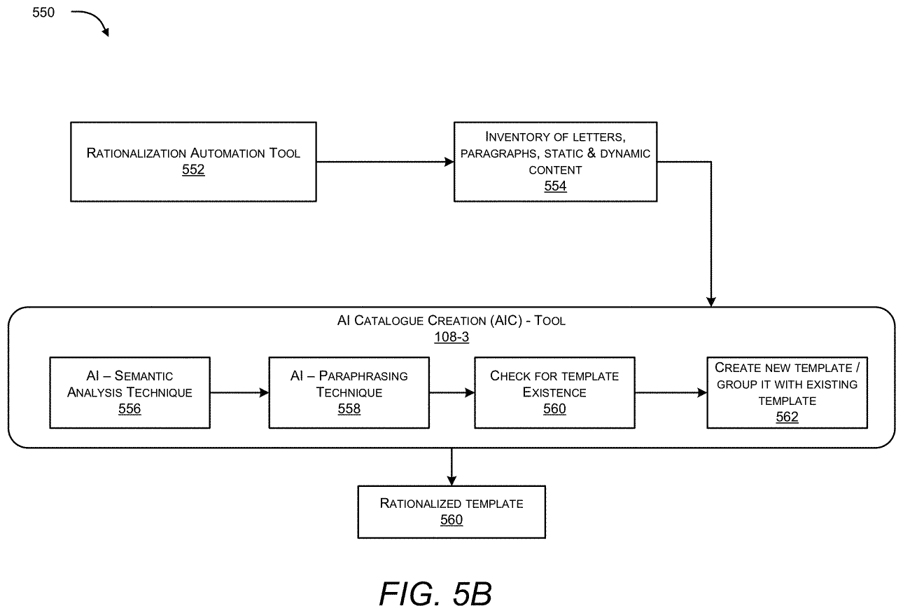

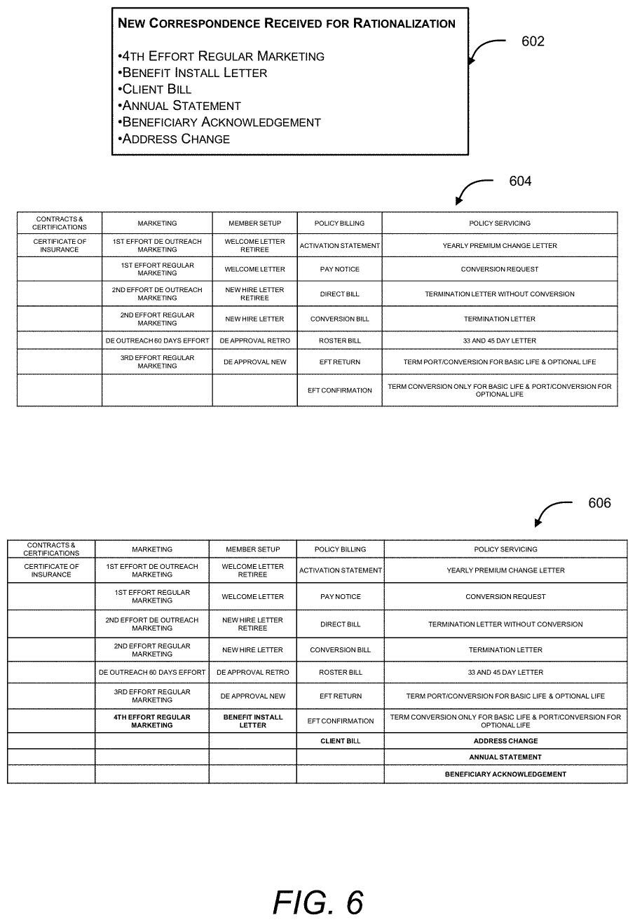

In an example embodiment, the DIRE (104) (of FIG. 1) may be operatively coupled with the AICRE 108 (of FIG. 1) for generation of the at least one rationalized template. The AICRE 108 may generate the rationalized template based on AI based paraphrasing and semantic analysis through the analysis of the identified static and dynamic objects. FIGS. 5A-5B illustrate exemplary representations 500 and 550 for the generation of the rationalized template through AICRE 108, according to an example embodiment of the present disclosure. The AICRE 108 may include AI based rationalization correspondence grouping (AI-RaCG) tool 108-1 and a AI template builder (AI-TB) tool 108-2. As illustrated in FIG. 5A, a rationalization automation tool 502 of the system may perform extraction of objects from a plurality of templates to identify the static objects and the dynamic objects (as explained in FIG. 2B). Based on the identified objects, a rationalization report 504 may be generated. The rationalization report 504 may be sent to the AI-TB (108-2) for further processing to automatically generate the rationalized template 504. The processing may include AI based semantic analysis 508 and AI based paraphrasing 510 through the analysis of the identified static and dynamic objects. In semantic analysis 508, the AI-TB (108-2) may check similar paragraphs in the rationalization report 504 to match the best available fit. The semantic analysis 510 may pertain to deriving meaning from a text. This may allow the system to understand and interpret sentences, paragraphs, or whole documents, by analyzing their grammatical structure, and identifying relationships between individual words in a particular context. In an example embodiment, the semantic analysis may be performed using techniques including Bidirectional Encoder Representations from Transformers (BERT) for measuring text similarity, cosine similarity, Euclidean distance, and other similar techniques. In the AI based paraphrasing 510, the AI-TB (108-2) may extract paragraphs from the plurality of templates for a given correspondence. By utilizing the AI based paraphrasing 510, the AI-TB (108-2) may generate meaningful statements from the extracted paragraphs. In an example embodiment, the AI based paraphrasing 510 may include rewriting text from the extracted paragraphs in different words and in the form of varying expressions. This is done without changing the context or meaning of the text to derive better clarity on the meaning of the extracted text. For example, the AI-TB (108-2) may facilitate the re-writing of the text by utilizing varying alternate words and varying sentence structuring through a sentence re-phrasing tool or a re-wording tool. In an example embodiment, the paraphrasing may be performed using techniques including Text-To-Text Transfer Transformer (T5), Bidirectional and Auto-Regressive Transformer (BART) for paraphrasing with simple transformers and other similar techniques. In an example embodiment, the AICRE 108 may include AI models for the paraphrasing and semantic analysis, wherein the models may be shelf model and may be customizable as per requirements of the data. In the next step, the AI-TB (108-2) may collate the paragraphs based on the object number mentioned in the rationalization report 504. Based on these steps, the AI-TB (108-2) may generate an output (in the form of rationalization template 528) based on an assessment 514 to check if a similar template exists or not. In an example embodiment, the output may be generated by building a new template (516), if no matching existing template may be found. In an alternate example embodiment, the output may be generated by grouping the correspondence with an existing template, if a matching template is found (516). In an example embodiment, the AI-TB (108-2) includes the AI learning engine 514 (also mentioned as 110 in FIG. 1) that receives the plurality of templates for the given correspondence. In an example embodiment, the AI learning engine 514 may learn from the generated at least one rationalized template for the given correspondence. Based on the learning, the AI learning engine 514 may be able to revise the at least one rationalized template upon receipt of another template for the given correspondence based on an AI document classification unit or classification technique 520. In an alternate embodiment, the AI-TB (108-2) may analyse a second correspondence (also referred hereinbelow as new correspondence 518) requiring rationalization and may provide recommended groupings of similar correspondences. In this embodiment, line of business (LOB) wise correspondences 516 that are already grouped (based on previous grouping or recommendation) may be accessed. These grouped correspondences are fed to the AI learning engine 514 for AI based learning. In a scenario when the new Correspondence 518 is added to the scope of rationalization, the AI learning engine 514 may facilitate comparison of the new correspondence across existing templates and may recommend grouping for rationalization 530 based on AI Document Classification technique 520. In an example embodiment, the recommendation pertaining to grouping for rationalization 530 may be sent to the Rationalization Automation Tool 502 as an input. The rationalized template 528 and corresponding group of correspondence may also be stored in the database of the system for future reference. Further, as shown in FIG. 5B, the AICRE 108 may include an AI catalogue creation (AIC) tool 108-3. In an example embodiment, rationalized inventory containing multiple samples extraction may be sent as input to the AIC tool (108-3). The AIC tool (108-3) may extract each of the paragraphs related to each sample. Further, using the AI semantic analysis technique 556, the AIC tool (108-3) may check for similar paragraphs in the inventory and try to match the best available fit. Furthermore, using the AI paraphrasing technique 558, the AIC tool (108-3) may assess if sentence(s) in the output paragraphs may require to be rephrased to make it more appealing. The AIC tool (108-3) may bring the paragraphs using the numbering order mentioned in the rationalized inventory to create a template (at 560) to obtain the rationalized template 564. In an example embodiment, grouping of the template too would be created (at 560). The AIC tool (108-3) may also check for the next inventory item, if the content matches to any existing template (at 562), and if not then the AIC tool (108-3) may create a template. FIG. 6 illustrates an exemplary representation 603, 604, 606 for showing recommendation of grouping of new correspondence by the learning engine 510, according to an example embodiment of the present disclosure. As illustrated in FIG. 6, a list of new correspondence for rationalization is received as shown in 602. As explained in FIG. 5A, the learning engine 514 may recommend grouping for rationalization based on AI Document Classification technique 520. The existing templates may pertain to LOB wise rationalized templates as shown in 604. Each template may belong to at least one group such, as for, example, marketing, policy billing and other groups as shown. At 606, it may be observed that, based on the recommendation by the learning engine 514, the new correspondence in 602 may be added to the at least one group of 604. For example, as observed in 606, the new correspondence labelled as “client bill” is added to the group pertaining to “policy billing” in 604. In another example, as observed in 606, the new correspondence labelled as “address change” is added to the group pertaining to “policy serving” in 604. Thus, based on the input or recommendation, the rationalization automation tool 502 may target templates pertaining to a particular group, thereby evading the need to access templates from irrelevant groups.

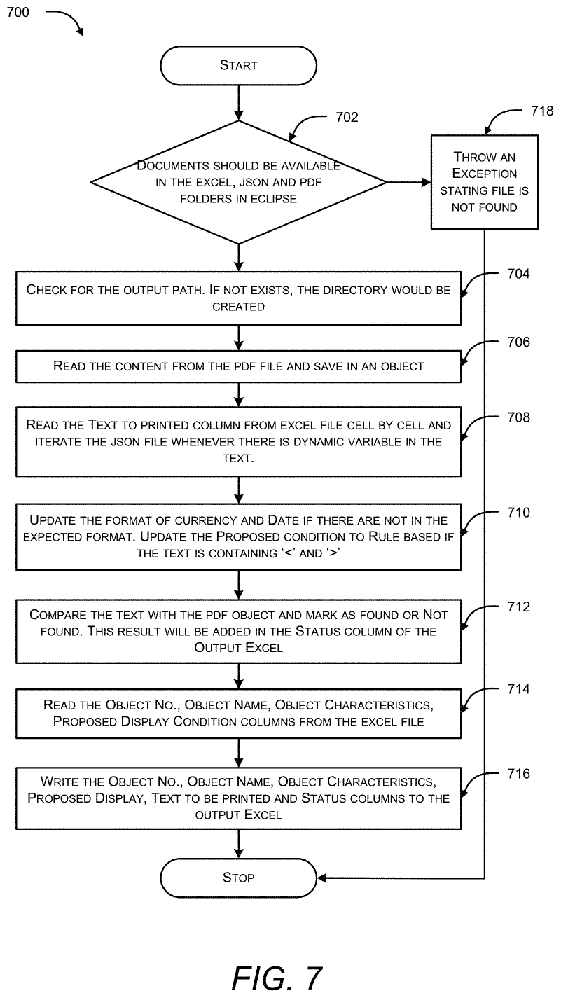

In an example embodiment, the at least one rationalized template is used to generate multiple forms of the given correspondence based on a set of rules. FIG. 7 illustrates an exemplary representation 800 of a test automation framework 700, according to an example embodiment of the present disclosure. At 702, as per the test automation framework, it may be assessed if the documents may be available in excel, json and pdf folders in eclipse. If yes, then at 704, it may be checked if an output path exists. If the output path may not exist, a directory may be created. At 706, content from the pdf file may be read and saved in an object. At 708, text to printed column may be read cell by cell from excel file and json file may be iterated whenever there is dynamic variable in the text. At 710, format of currency and date may be updated if the format may not be in the expected form. The proposed condition may be updated based on pre-defined rule, such as, for example, the formatting may be performed if the text may contain “<” and “>”. The format requirements may be essential for displaying data in desired way, such as, for example, dates 24 Nov. 2021 or 24/11/2021. In another embodiment, the rule related to ‘<’ or ‘>’ may be also be used to state that the text under these tags are populated based on some logic/rules and has to be manually verified by the testing team. At 712, text may be compared with the pdf object and is marked as found or not found. The corresponding result may be added in the status column of the output excel. At 714, the object number, object name, object characteristics, proposed display condition columns may be read from the excel file. At 716, object number, object name, object characteristics, proposed display, text to be printed and status columns may be written to the output excel. At 702, if the documents may not be available in the mentioned format, then an exception may be considered stating reason to be as “file not found”. In an example embodiment, the test automation framework may be completely automated. In another example embodiment, the test automation framework may be partly automated and may need manual intervention.

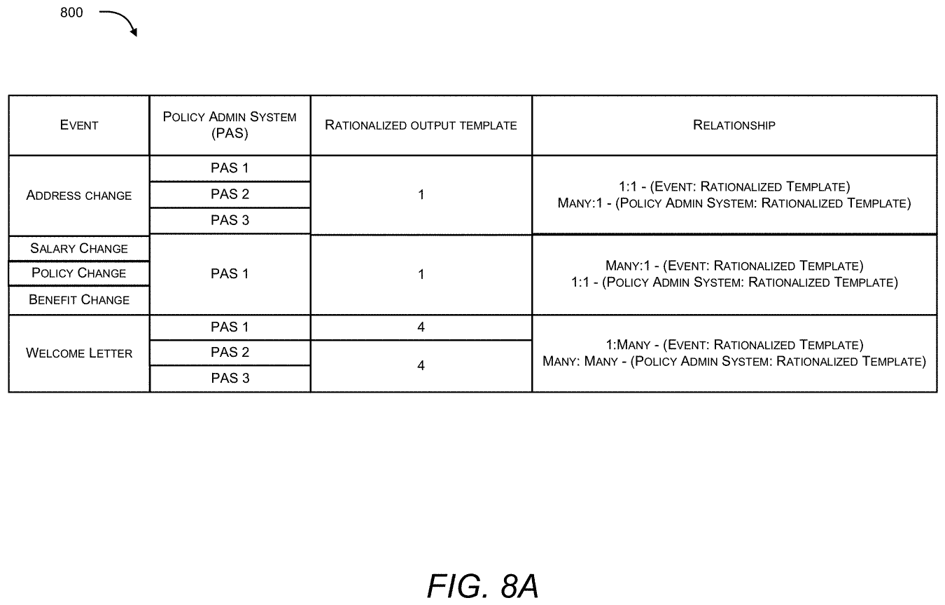

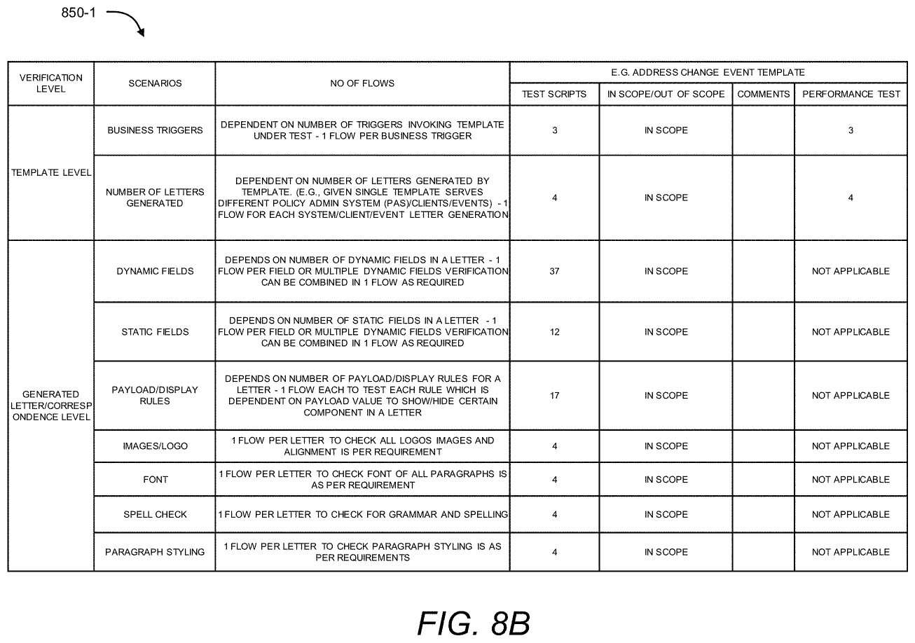

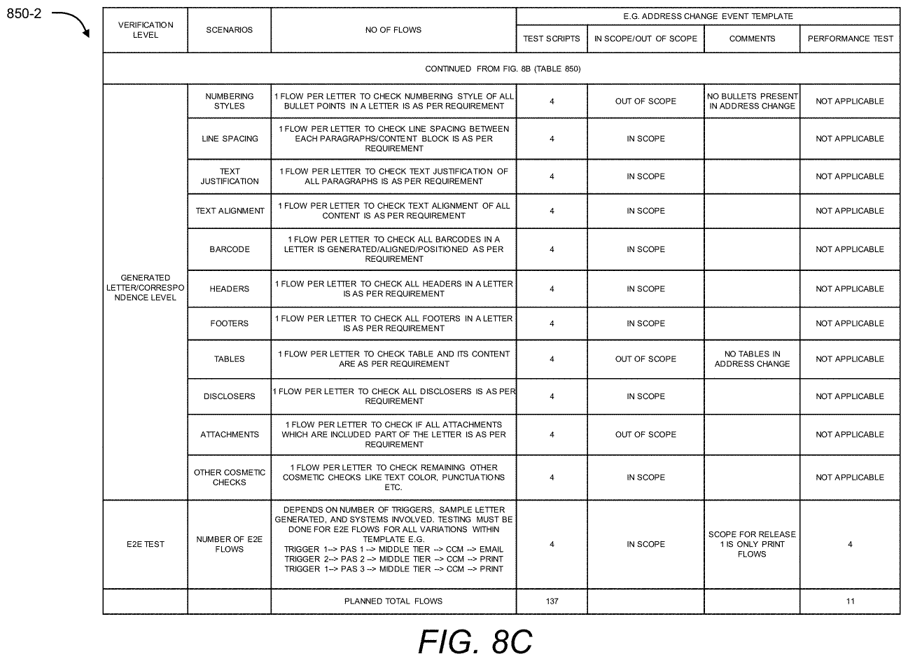

In an example embodiment, a testing framework may be utilized to identify comprehensive testing flows/scenarios on a pre-defined level. The comprehensive testing flows/scenarios may facilitate to evaluate the effectiveness or performance of the system with respect to the digital rationalization. In an example embodiment, the pre-defined level may be at least of a template level, generated correspondence level and end-to-end (E2E) level for the at least rationalized template generated by the system (across policy admin system and/or events). The testing framework may facilitate to obtain number of comprehensive testing flows/scenarios required for comprehensive testing of the rationalized template. In an example embodiment, the framework can be customized to each individual template based on scope of testing. The template level verification facilitates to check if correct templates have been generated or not. FIG. 8A illustrates an exemplary representation 800 of the template level verification, according to an example embodiment of the present disclosure. In an example embodiment, the template level verification may pertain to verification of aspects, such as, for example, the trigger conditions, verification of relationships of templates (with event or policy adding system) and number of letters generated, and other such aspects. In an example and illustrated in FIG. 8A, first entry in 800 may pertain to only one event (address change), 3 different policy admin system (PAS 1, 2, 3) and one rationalized template. Hence, the relationship between event and rationalized template may be 1:1 and the PAS and the rationalized template may be Many:1. In another example and illustrated in FIG. 8A, second entry in 800 may pertain to 3 events, one PAS and one rationalized template. Hence, in the instant example, the relationship between event and rationalized template is Many:1 and the PAS and the rationalized template is 1:1.

In an alternate embodiment, the pre-defined level may pertain to correspondence level. The correspondence level may include verification of testing content and attributes of the objects configured on the rationalized template. In another alternate embodiment, the pre-defined level may pertain to E2E Level. The E2E Level may include verification testing correspondences generated from E2E flows and data flow from all involved systems. FIGS. 8B-80 illustrate exemplary representations 850-1 and 850-2 of various verification levels in a testing framework, according to an example embodiment of the present disclosure. As illustrated in FIGS. 8B and 8C, the illustrated table in 850-1 and 850-2 depict a testing framework for an event or correspondence related to “Address change.” The first set of entry in the table (850-1) is related to template level verification. The template level verification mainly attributes to scenarios such as, for example, business triggers and number of letters generated. The number of flows in the scenario “business triggers” may be dependent on number of triggers invoking template under test. For example, the number of flow for each business trigger can be pre-defined to be “1” and test scripts may be “3”, The term “test scripts” may represent test steps involved to test each test condition in each scenario. For example, if for Address change template, the scenario is to test “Business Triggers”, and assuming there are 3 different triggering events i.e. 1) When customer change address through website; 2) Customer dials in and agent changes address; and 3) There is a feed from USPS with address change event. All the above three events may invoke address change template so that each flow may be a test condition/test script. Further, the entries corresponding to the column “in scope/out of scope” may be corresponding to applicable scenarios or test conditions for a given template under test. For example, for entries corresponding to Correspondence level (second entry in FIGS. 8B and 8C), in the address change template, it may be assumed that the letters which are generated do not contain any bullets/numberings within the letters. Thus, in that case the scenarios with respect to test “Numbering Styles” Row (in FIG. 8C) may be not in scope of address change testing. This may also indicate that the numbering styles testing scenarios for address change template are not in scope for correspondence level testing. Similarly, in case of entries corresponding to E2E level (last entry in FIG. 8C), among the three case scenarios/flows, case flows 2 and 3 may be in scope of E2E flows testing, whereas for flow 1 may not in scope of release 1. In these 3 flows, the term “trigger” may refer to first system where triggering is done to invoke a template, and the term PAS or may refer to Policy Admin System that generates payload (dynamic data) and sends to Middle Tier, which may perform additional data conditioning and sends the required payload to CCM. The CCM Tool may receive the payload from Middle Tier and invokes/fills data into Address Change (Open Text Template) and may further generate letter in PDF format, which may be sent through email (as shown in flow 1) or for printing purpose (as shown in flows 2 and 3). Similarly, even in case of entries corresponding to template level (first entry in FIG. 8B), in Address Change template, the business triggers may not be set up for release 1 and template gray be ready on CCM tool, By using mock data payload, the system/testing team may generate all the different letters configured on the template and perform their testing on the template. In this case, the scenarios pertaining to the business triggers may not be in scope for release 1 for template level testing. The number of flows in the scenario “number of letters generated” may be dependent on number of letters or documents pertaining to a generated rationalized template. For example, if a single template serves different policy admin system (PAS)/clients/events, then a single flow may be attributed to each system/client/event. The correspondence level verification may include verification of testing content and attributes of the objects configured on the rationalized template, such as, for example, numbering styles, line spacing, text justification, text alignment and other aspects as mentioned in table (850-1 and continued portion in 850-2). The E2E level verification may include testing that depends on number of triggers, sample letter generated, and systems involved. The testing in the E2E level verification may be performed for all variations within a template. The testing framework can be beneficial for identifying all possible testing flows for comprehensive rationalized template testing. The testing framework may also be customized to include new verification flows at various levels. The last column pertaining to “performance testing” may depend on the requirement from clients. For example, in agile projects, the template level performance testing is performed in sprint testing and may be performed with mock data or by simulating business triggering events to generate required amount of data. Based on performance test requirements given by client, template may be tested for number of letters generated per given load. The performance testing may not be done on objects present in correspondence hence it may be marked “NA” for correspondence level testing. The performance testing may be optional for E2E flows but can be done to check performance for different E2E flows.

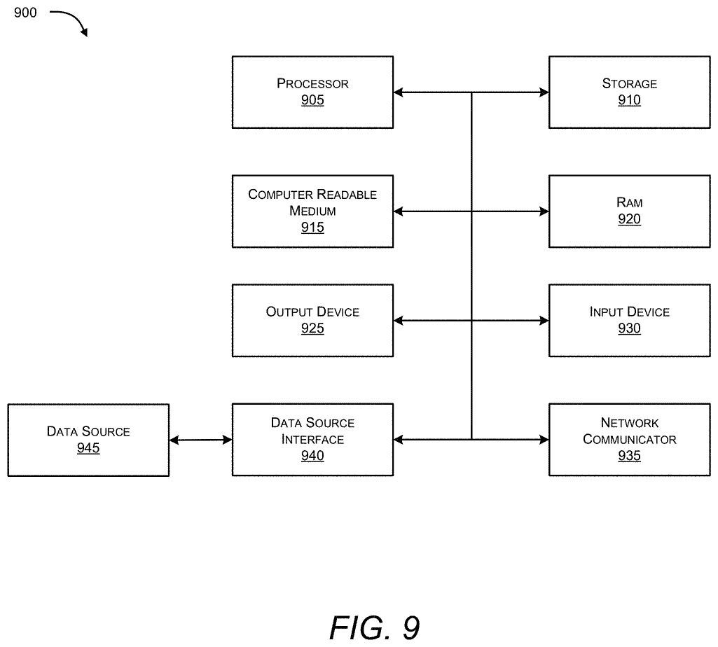

FIG. 9 illustrates a hardware platform (900) for implementation of the disclosed system, according to an example embodiment of the present disclosure. For the sake of brevity, construction and operational features of the system 100 which are explained in detail above are not explained in detail herein. Particularly, computing machines such as but not limited to internal/external server clusters, quantum computers, desktops, laptops, smartphones, tablets, and wearables which may be used to execute the system 100 or may include the structure of the hardware platform 900. As illustrated, the hardware platform 900 may include additional components not shown, and that some of the components described may be removed and/or modified. For example, a computer system with multiple GPUs may be located on external-cloud platforms including Amazon Web Services, or internal corporate cloud computing clusters, or organizational computing resources, etc.

The hardware platform 900 may be a computer system such as the system 100 that may be used with the embodiments described herein. The computer system may represent a computational platform that includes components that may be in a server or another computer system. The computer system may execute, by the processor 905 (e.g., a single or multiple processors) or other hardware processing circuit, the methods, functions, and other processes described herein. These methods, functions, and other processes may be embodied as machine-readable instructions stored on a computer-readable medium, which may be non-transitory, such as hardware storage devices (e.g., RAM (random access memory), ROM (read-only memory), EPROM (erasable, programmable ROM), EEPROM (electrically erasable, programmable ROM), hard drives, and flash memory). The computer system may include the processor 905 that executes software instructions or code stored on a non-transitory computer-readable storage medium 910 to perform methods of the present disclosure. The software code includes, for example, instructions to generate the rationalized template. In an example, the DTRE 104, AICRE 108, learning engine 110 may be software codes or components performing these steps.

The instructions on the computer-readable storage medium 910 are read and stored the instructions in storage 915 or in random access memory (RAM). The storage 915 may provide a space for keeping static data where at least some instructions could be stored for later execution. The stored instructions may be further compiled to generate other representations of the instructions and dynamically stored in the RAM such as RAM 920. The processor 905 may read instructions from the RAM 920 and perform actions as instructed.

The computer system may further include the output device 925 to provide at least some of the results of the execution as output including, but not limited to, visual information to users, such as external agents. The output device 925 may include a display on computing devices and virtual reality glasses. For example, the display may be a mobile phone screen or a laptop screen. GUIs and/or text may be presented as an output on the display screen. The computer system may further include an input device 930 to provide a user or another device with mechanisms for entering data and/or otherwise interact with the computer system. The input device 930 may include, for example, a keyboard, a keypad, a mouse, or a touchscreen. Each of these output device 925 and input device 930 may be joined by one or more additional peripherals. For example, the output device 925 may be used to display the rationalized report and/or rationalized template that is generated by the system 100.

A network communicator 935 may be provided to connect the computer system to a network and in turn to other devices connected to the network including other clients, servers, data stores, and interfaces, for instance. A network communicator 935 may include, for example, a network adapter such as a LAN adapter or a wireless adapter. The computer system may include a data sources interface 940 to access the data source 945. The data source 945 may be an information resource. As an example, a database of exceptions and rules may be provided as the data source 945. Moreover, knowledge repositories and curated data may be other examples of the data source 945.

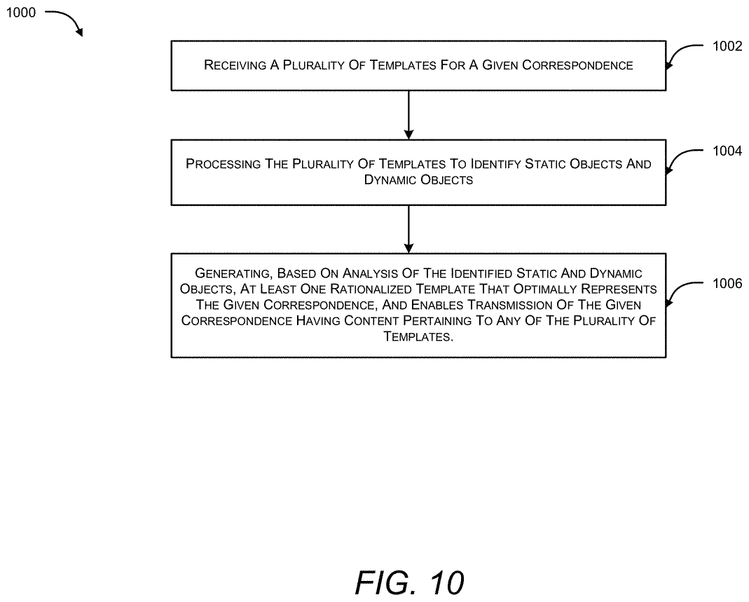

FIG. 10 illustrates a flow diagram 1000 for facilitating digital rationalization of a correspondence, according to an example embodiment of the present disclosure. At 1102, the method includes a step of receiving a plurality of templates for a given correspondence. At 1104, the method includes a step of processing the plurality of templates to identify static objects and dynamic objects. The static objects may be indicative of components that are common across the plurality of templates. The dynamic objects may be indicative of components that vary across the plurality of templates. At 1104, the method includes a step of generating, based on analysis of the identified static and dynamic objects, at least one rationalized template that optimally represents the given correspondence, and enables transmission of the given correspondence having content pertaining to any of the plurality of templates. In an example embodiment, the step of processing of the plurality of templates includes identifying recurring objects that are indicative of components that re-occur across a set of templates of the plurality of templates. In an alternate example embodiment, the step of generating of the at least one rationalized template includes determining variances between the dynamic objects, rationalizing the determined variances, and merging the rationalized variances with the static objects to generated the at least one rationalized template.

One of ordinary skill in the art will appreciate that techniques consistent with the present disclosure are applicable in other contexts as well without departing from the scope of the disclosure.

What has been described and illustrated herein are examples of the present disclosure. The terms, descriptions, and figures used herein are set forth by way of illustration only and are not meant as limitations. Many variations are possible within the spirit and scope of the subject matter, which is intended to be defined by the following claims and their equivalents in which all terms are meant in their broadest reasonable sense unless otherwise indicated.

I/We claim:

1. A system comprising:
a document template rationalization engine, which when executed using
a processor, causes the engine to:
receive, from at least one database, a plurality of templates for a given correspondence;
process the plurality of templates to identify static objects and dynamic objects, wherein the static objects are indicative of components that are common across the plurality of templates, and wherein the dynamic objects are indicative of components that vary across the plurality of templates; and
generate, based on analysis of the identified static and dynamic objects, at least one rationalized template that optimally represents the given correspondence, and enables transmission of the given correspondence having content pertaining to any of the plurality of templates.

2. The system as claimed in claim 1, wherein processing of the plurality of templates enables further identification of recurring objects that are indicative of components that re-occur across a set of templates of the plurality of templates.

3. The system as claimed in claim 1, wherein the plurality of templates are stored across multiple document file formats.

4. The system as claimed in claim 1, wherein the at least one rationalized template is generated by:
determining variances between the dynamic objects;
rationalizing the determined variances; and
merging the rationalized variances with the static objects to generated the at least one rationalized template.

5. The system as claimed in claim 4, wherein the variances between the dynamic objects are determined based on evaluation of an interstate variance possibility.

6. The system as claimed in claim 1, wherein the document template rationalization engine is executed across a plurality of stages, each stage of the plurality of stages being based on how the plurality of templates are stored within and/or across one or more legacy systems.

7. The system as claimed in claim 1, wherein the at least one rationalized template is used to generate multiple forms of the given correspondence based on a set of rules.

8. The system as claimed in claim 1, wherein a unique identifier is associated with each of the static object and/or the dynamic object.

9. The system as claimed in claim 1, wherein the at least one rationalized template is indicative of static objects and dynamic objects that are required for generation of the given correspondence having content pertaining to any of the plurality of templates.

10. The system as claimed in claim 1, wherein the static objects and the dynamic objects are portions of text that form part of the plurality of templates.

11. The system as claimed in claim 1, wherein the processing further comprises assessing occurrence of each identified object across each template of the plurality of templates, based on which the identified object is determined to be unique, common, or re-occurring.

12. The system as claimed in claim 1, wherein the document template rationalization engine is operatively coupled with an artificial intelligence (AI) based correspondence rationalization engine, wherein the AI based correspondence rationalization engine, based on the analysis of the identified static and dynamic objects, enables generation of the at least one rationalized template based on AI based paraphrasing and semantic analysis.

13. The system as claimed in claim 12, wherein the AI based correspondence rationalization engine comprises a learning unit that receives the plurality of templates for the given correspondence and learns from the generated at least one rationalized template for the given correspondence so as to be able to revise the at least one rationalized template upon receipt of another template for the given correspondence based on a AI document classification unit.

14. The system as claimed in claim 12, wherein the AI based correspondence rationalization engine analyses a second correspondence requiring rationalization and provides recommended groupings of similar correspondences.

15. The system s claimed in claim 1, wherein a testing framework may be utilized to identify comprehensive testing flows on a pre-defined level for evaluation of performance of the system with respect to the digital rationalization, wherein the pre-defined level may be at least of a template level, generated correspondence level and end-to-end (E2E) level.

16. A method for digital rationalization of a correspondence, the method comprising:
receiving, by a processor, a plurality of templates for a given correspondence;
processing, by the processor, the plurality of templates to identify static objects and dynamic objects, wherein the static objects are indicative of components that are common across the plurality of templates, and wherein the dynamic objects are indicative of components that vary across the plurality of templates; and
generating, by the processor, based on analysis of the identified static and dynamic objects, at least one rationalized template that optimally represents the given correspondence, and enables transmission of the given correspondence having content pertaining to any of the plurality of templates.

17. The method as claimed in claim 16, the processing of the plurality of templates comprising:
identifying, by the processor, recurring objects that are indicative of components that re-occur across a set of templates of the plurality of templates.

18. The method as claimed in claim 16, the generating of the at least one rationalized template comprising:
determining, by the processor, variances between the dynamic objects;
rationalizing, by the processor, the determined variances; and
merging, by the processor, the rationalized variances with the static objects to generated the at least one rationalized template.

19. A non-transitory computer readable medium, wherein the readable medium comprises machine executable instructions that are executable by a processor to:
receive a plurality of templates for a given correspondence;
process the plurality of templates to identify static objects and dynamic objects, wherein the static objects are indicative of components that are common across the plurality of templates, and wherein the dynamic objects are indicative of components that vary across the plurality of templates; and
generate, based on analysis of the identified static and dynamic objects, at least one rationalized template that optimally represents the given correspondence, and enables transmission of the given correspondence having content pertaining to any of the plurality of templates.

20. The non-transitory computer readable medium as claimed in claim 19, wherein the readable medium comprises machine executable instructions that are executable by a processor to:
determine variances between the dynamic objects;
rationalize the determined variances; and
merge the rationalized variances with the static objects to generated the at least one rationalized template.
